(19) United States
(12) Patent Application Publication
(10) Pub. No.: US 2015/0155573 A1
(43) Pub. Date: Jun. 4, 2015

(54) FUEL CELL COOLING APPARATUS AND FUEL CELL COOLING METHOD USING THE SAME

(71) Applicant: HYUNDAI MOTOR COMPANY, Seoul (KR)

(72) Inventors: Jang Ho Jo, Yongin (KR); Hyuck Roul Kwon, Yongin (KR)

(21) Appl. No.: 14/508,263

(22) Filed: Oct. 7, 2014

(30) Foreign Application Priority Data
Nov. 29, 2013 (KR) 10-2013-0147236

(51) Int. Cl. H01M 8/04

(52) U.S. Cl. CPC H01M 8/04029; H01M 8/04067; H01M 8/04134; H01M 8/04701; H01M 8/0485; H01M 2250/20

(57) ABSTRACT

A fuel cell cooling apparatus and a fuel cell cooling method are provided. In particular, an evaporating/cooling unit installed in a stack of a fuel cell is utilized to lower a temperature of a stack and an injector injects a cooling material into the evaporating/cooling unit. A pump applies the pressure necessary for injecting the cooling material; and a passage connects the evaporating/cooling unit to a cathode and disposed in the fuel cell cooling apparatus so that the cooling material evaporated in the evaporating/cooling unit passes through the passage and to the cathode.

### CROSS-REFERENCE TO RELATED APPLICATION

This application claims under 35 U.S.C. §119(a) the benefit of Korean Patent Application No. 10-2013-0147236, filed on Nov. 29, 2013, the entire contents of which are incorporated herein by reference.

### BACKGROUND

(a) Technical Field

The present invention relates to a fuel cell cooling apparatus. More particularly, the present invention relates to cooling apparatus for a fuel cell and a cooling method thereof.

(b) Background Art

Fuel cells typically directly convert chemical energy generated due to oxidation of a fuel into electrical energy. Fuel cells come in many different varieties. For example, some fuel cells operate under low temperatures and ambient pressure while others operate at high temperatures and under high pressure. This distinction is due to the reaction temperatures and pressures within the fuel cell.

FIG. 6 is a view showing a typical low-temperature/ambient pressure fuel cell. The low-temperature/normal-pressure fuel cell for the most part includes a stack 10 in which hydrogen reacts with oxygen, a hydrogen supply unit 20 that supplies hydrogen to the stack 10, an air supply unit 30 that supplies air to the stack 10, and a cooling unit 40 that cools the stack 10.

The stack 10 includes an anode 11 to which hydrogen is introduced, a cathode for receiving air, and a cooler 13 for cooling the stack 10.

The hydrogen supply 20 includes a valve 21 responsible for opening and closing a hydrogen supply passage, an ejector 22 for ejecting hydrogen to the anode 11 of the stack 10, and a purge valve 22 for discharging residual substances generated during the reaction from the anode 11.

The air supply 30 includes an air filter 31 that removes foreign substances from air that is injected into the stack 10, a pump 32 that supplies air to the cathode 12, and a humidifier 33 that provides moisture to air flowing to the cathode 12 through the pump 32.

The cooling unit 40 includes a coolant reservoir 41 for storing coolant, a coolant pump 42 for pumping the coolant from the coolant reservoir 41 to the cooler 13 of the stack 10, a radiator 43 to cool the coolant discharged from the cooler 13 via passing air over the radiator 43 by operating a fan 44 s.

A process of humidifying a low-temperature/normal-pressure fuel cell and a process of cooling the low-temperature/normal-pressure fuel cell will be described as follows. Humid air discharged from the cathode 12 of the stack 10 is sent to a gas-to-gas humidifier to serve as a moisture supply source for the humidifier 33. Dry air supplied to the humidifier is humidified while passing through the humidifier 33, and is reintroduced into the cathode 12 of the stack 10 once it has been humidified. In this cooling configuration, the stack 10 is cooled by a separate anti-freeze solution, and the hot coolant exiting from an outlet of the stack 10 is cooled by the radiator 43.

These low-temperature/normal-pressure fuel cells can be operated at a low temperature in a low output condition, and can sufficiently supply moisture to the stack. Thus, a high performance of the stack can only be maintained in low output conditions. However, a separate humidification control system is not necessary during low-output conditions.

Additionally, in these types of systems, the size of the radiator 43 should be as large as possible in order to remove a significant amount of heat from the coolant that is exiting in the stack 10 during a high output. As such, due to the size of the radiator that would be required to effectively cool this type of fuel cell in a fuel cell vehicle, these types of systems are not able to be implemented into the vehicles without significant modification to the vehicle.

Accordingly, high temperature operation (i.e., 80° C. to 100° C.). is essential to maintaining a continuous high output system. However, since it is difficult to properly supply moisture from a humidifier 33 during a high temperature operation, moisture supplied from an electrolyte membrane of the stack 10 is often blocked so that it is difficult to continuously operation a fuel cell.

FIG. 7 is a block diagram showing a high-temperature/high-pressure fuel cell system. The basic configuration of the high-temperature/high-pressure fuel cell system is basically similar to the low-temperature/normal-pressure fuel cell system of FIG. 6. These type of systems additionally include a back pressure adjusting valve 34 that is installed at an exhaust end of the air supply unit 30 to increase the pressure within the cathode 12 (i.e., an air electrode). Additionally, rather than utilizing the pump 32 of the low-temperature/normal-pressure fuel cell system, a compressor is used in its place.

As such, these systems operate differently only in that an operation pressure and an operation temperature of the high-temperature/high-pressure fuel cell system are higher than those of the low-temperature/normal-pressure fuel cell system, but a configuration of the cooling unit 40 for cooling a stack is basically similar to that of the low-temperature/normal-pressure type system.

The humidifying portion for supplying moisture into the stack 10 of the fuel cell in high temperature/high pressure fuel cell is the same as that of the low-temperature/normal-pressure type system for the most part. The only difference is the operation pressure is higher than in the ambient pressure system.

High-temperature/high-pressure fuel cell systems are advantageous in that the amount humidification necessary to maintain the proper amount of moisture at an electrolyte membrane is low due to the increase of an operation pressure. Thus, the size of the humidifier 33 can be reduced. Further, since a heat radiating amount is large even in the radiator having the same size as that of the low-temperature/normal-pressure type system due to a high operation temperature (e.g., 80° C. to 100° C.), and as such a high output operational characteristics can be continuously maintained.

However, in the high-temperature/high-pressure fuel cell, the power consumption of an air supplier is increased and accordingly the efficiency of the entire system is decreased as a result. In particular, moisture is removed from an electrolyte membrane and a performance of the stack 10 decreases due to a rise in operation temperature, and an efficiency of the entire system is decreased as an amount of hydrogen passing through the system increases. Further, a possibility of leakage of gas and the coolant increases, and thus durability and quality of the fuel cell deteriorate. In addition, the system becomes complex due to the pressure increase, as such this lowers the stability of the system.

### SUMMARY OF THE DISCLOSURE

The present invention has been made in an effort to solve the above-described problems of the low-temperature/normal-pressure fuel cell and the high-temperature/high-pressure fuel cell according to the related art, and it is an object of the present invention to provide a fuel cell cooling apparatus by which sufficient heat radiating performance can be secured while high temperature operation is enabled and a cooling method using the same.

It is another object of the present invention to provide a fuel cell cooling apparatus by which increases the performance of a stack by sufficiently supplying moisture higher temperatures and a cooling method using the same.

It is still another object of the present invention to provide a fuel cell cooling apparatus by which reduction of system efficiency during high output can be prevented by utilizing a ambient pressure operation and a cooling method using the same.

In accordance with an aspect of the present invention, there is provided a fuel cell cooling apparatus including: an evaporating/cooling unit (e.g., an evaporator/cooler) installed in a stack of a fuel cell, that is operably configured to lower a temperature of a stack; an injector operably configured to inject a cooling material (e.g., water) that is to be used in the evaporating/cooling unit; a pump that is operably configured and connected to apply the amount of pressure necessary in order to inject the cooling material to the injector; and a passage connected and configured to provide a passage for the cooling material evaporated from the evaporating/cooling unit to a cathode of the stack of the fuel cell.

The cathode may supply the cooling material injected from the pipe passage and evaporated to an electrolyte membrane. The fuel cell cooling apparatus may further include: a radiator that emits heat from the cooling material to outside the system to liquefy the evaporated cooling material left after being supplied from the cathode to the electrolyte membrane. Furthermore, a fan is operably disposed and configured to blow air toward or over the radiator to increase the heat transfer efficiency of the radiator. Additionally, a water pump is operably disposed and configured in the system to supply the cooling material to the injector, and a reservoir is operably disposed and configured in the system to store water produced during a chemical reaction between the hydrogen and oxygen in the stack of the fuel cell and as well as water retrieved from the radiator.

In accordance with another aspect of the present invention, there is provided a fuel cell cooling method that includes injecting a cooling material (e.g., water) into an evaporator/cooler; evaporating the cooling material in the evaporating/cooling unit; introducing the evaporated cooling material to a cathode of a fuel cell; and supplying moisture to an electrolyte membrane of the cathode of the fuel cell by using the evaporated cooling material introduced into the cathode of the fuel cell.

The fuel cell cooling apparatus may further include: after supplying moisture to an electrolyte membrane of the cathode of the fuel cell by using the evaporated cooling material introduced into the cathode of the fuel cell, emitting heat from the evaporated cooling material to liquefy the cooling material; and storing the liquefied cooling material.

As described above, the fuel cell according to the related art has the following effects.

First, a stack can be cooled by using latent heat within the water and a large amount of evaporated moisture can be directly supplied to an air electrode. Thus, a performance of the stack can be maintained even at high temperatures by preventing an electrolyte membrane from becoming dried out.

Second, the efficiency of the system can be increased by the system being above to be operated at a high temperature (e.g., 80° C. to 100° C.) even at a ambient pressure.

Third, since humidifying performance can be increased even at these higher temperatures, a sufficient amount of moisture can be provided to an electrolyte membrane of an air electrode while still preventing a reduction in performance to the stack at these higher temperatures.

Fourth, the overall size of the system can be decreased due to the allowable reduction in size of the humidifier for providing moisture to the stack through the use of an injector instead of a hollow membrane type humidifier.

Fifth, a thermal capacity of the stack can be decreased by eliminating a separate coolant from the stack. Thus, startup performance of the stack at lower temperatures (i.e., below freezing) can be improved.

Sixth, since dry air at a high temperature (e.g., 80° C. to 100° C.) can be supplied to the stack, water can be effectively removed from a membrane electrode assembly even when the fuel cell is stopped at a below zero temperature and thus durability is improved.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a block diagram showing constituent elements of a fuel cell according to an exemplary embodiment of the present invention;

FIG. 2 is a graph depicting operation temperatures according to loads of a high-temperature/normal-pressure fuel cell system to which a fuel cell cooling apparatus according to an exemplary embodiment of the present invention is applied;

FIG. 3 is a graph depicting a relationship between an amount of coolant supplied to the high-temperature/normal-pressure fuel cell system to which the fuel cell cooling apparatus according to the exemplary embodiment of the present invention and an amount of coolant generated in a stack;

FIG. 4 is a graph depicting a relationship between an amount of heat of the stack due to an increase of a load and an cooling amount corresponding thereto in the high-temperature/normal-pressure fuel cell system to which the fuel cell cooling apparatus according to the exemplary embodiment of the present invention is applied;

FIG. 5 is a graph showing humidity of an inlet and an outlet of the stack in the high-temperature/normal-pressure fuel cell system to which the fuel cell cooling apparatus according to the exemplary embodiment of the present invention is applied;

FIG. 6 is a view showing a low-temperature/ambient pressure fuel cell; and

FIG. 7 is a block diagram showing a high-temperature/high-pressure fuel cell system.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. The present invention may be various modified and may have various forms, and specific embodiments of the present invention will be depicted in the drawings and described in the detailed description of the present invention. However, the present invention is not limited to the specific disclosure forms, and includes all modifications, equivalents, and replacements that are included in the spirit and technical range of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid fuel cell vehicles, electric fuel cell vehicles, plug-in hybrid fuel cell electric vehicles, hydrogen-powered fuel cell vehicles, regular fuel cell vehicles, etc. As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

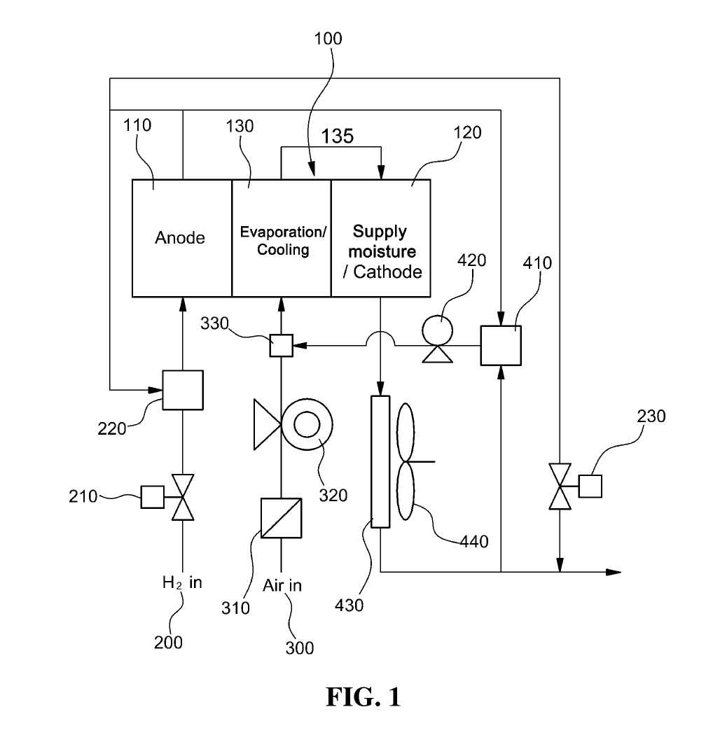

FIG. 1 is a block diagram showing constituent elements of a fuel cell according to an exemplary embodiment of the present invention. The fuel cell according to the exemplary embodiment of the present invention may be referred to as a high-temperature/ambient pressure fuel cell in that air supplied to a stack 100 of the fuel cell is air of high temperature and ambient pressure.

The concept of a ambient pressure differs from the concept of pressurization, and may refer to atmospheric pressure. That is, while a high-pressure fuel cell uses a compressor to inject air into an air electrode at a pressure higher than atmospheric pressure, the high-temperature/normal-pressure fuel cell provided with the fuel cell cooling apparatus according to the exemplary embodiment of the present invention uses a pump to inject air into an air electrode so that the pressure thereof is remarkably low compared to the high-pressure fuel cell described above. Thus, a pressure for injecting air into the air electrode by the fuel cell provided with the fuel cell cooling apparatus according to the exemplary embodiment of the present invention may be referred to as a normal or atmospheric pressure.

While a general high-temperature/high pressure system is mostly operated after a stack air outlet pressure is raised to about 0.4 bar gauge or higher at a temperature of 80° C. or higher by utilizing a back pressure control valve mounted at an outlet of air supply, the fuel cell cooling apparatus according to the exemplary embodiment of the present invention can be operated while a stack air outlet pressure is at an atmospheric pressure of 0.0 bar gauge. Thus, the ambient pressure in the disclosure of the present invention may be referred to as 0.0 bar gauge or atmospheric.

A fuel cell according to an exemplary embodiment of the present invention includes a stack 100, a hydrogen supply unit 200 for injecting hydrogen into an anode 110 of the stack 100, an air supply unit 300 for supplying air to a cathode 120 of the stack 100 through an evaporation/cooling unit 130 of the stack 100, and a cooling/circulating system for dissipating heat from the stack 100 of the fuel cell.

The hydrogen supply unit 200 of the fuel cell according to the exemplary embodiment of the present invention may include a valve 210 responsible for opening and closing a hydrogen supply passage, an ejector 220 used to inject hydrogen to the anode 110 of the stack 100, and a purge valve 230 that is repeatedly switched on and off through a purge control mechanism to effectively discharge a residual substances generated in the anode 110 of the stack 100 to the outside.

The air supply unit 300 of the fuel cell according to the exemplary embodiment of the present invention receives water from the circulating/cooling system of the fuel cell, supplies the water to the evaporating/cooling unit 130 of the stack 100, and supplies heated air to the cathode 120 of the stack 100 together with the evaporated moisture. That is, the air supply unit 300 and the cooling unit of the fuel cell are part of the same unit and are operated together.

Thereto, the air supply unit 300 of the fuel cell according to the exemplary embodiment of the present invention may include an air filter 310 installed in the air supply passage to remove contaminants within air being introduced, a pump 320 for blowing the air purified via the air filter 310 into the stack 100, an injector 330 for mixing the air injected from the pump 320 with a cooling material and injecting the mixed material into the evaporating/cooling unit 130 of the stack 100.

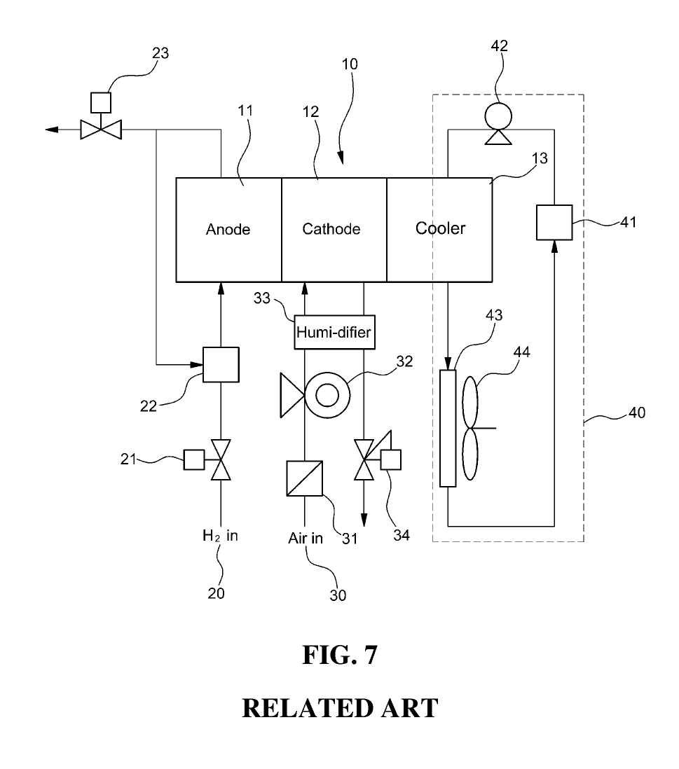

The reason why the fuel cell according to the exemplary embodiment of the present invention is called a high-temperature/normal-pressure fuel cell is that a pump or blower 320 (i.e., acting like a fan) is used to supply air to the stack 100 in order to apply the required pressure for injecting air into the stack 100 rather than a compressor like in the related in FIG. 7 which increases the pressure in the system above atmospheric.

Thus, since the fuel cell according to the exemplary embodiment of the present invention is a high-pressure/normal-pressure type, it can overcome a problem of lowering efficiency during high output conditions as is the case in a high-temperature/high-pressure type.

Hereinafter, the circulating/cooling system of the fuel cell according to the embodiment of the present invention will be described.

As described above, the circulating/cooling system of the fuel cell according to the exemplary embodiment of the present invention is coupled to the air supply unit 300 to supply moisture to the cathode of the stack 100 and cool the stack 100 at the same time.

The coolant reservoir 410 may store a cooling material that will be used in the fuel cell according to the exemplary embodiment of the present invention. The cooling material may be water, and the water may be referred to as a coolant. However, the cooling material according to the exemplary embodiment of the present invention is not limited to just water. For convenience, however, the cooling material is assumed to be water below, and a method of cooling the stack 100 of the fuel cell according to the exemplary embodiment of the present invention will be described.

More specifically, the coolant stored in the coolant reservoir 410 may be suctioned by the coolant pump 420 and may be injected into the injector 330 in the air supply passage.

The coolant in the injector 330 may then be mixed with air purified via the air filter 310 and may be supplied to the evaporating/cooling unit 130 of the stack 100.

The coolant injected into the evaporating/cooling unit 130 of the stack 100 of the fuel cell is immediately evaporated due to the heat of the stack 100, and the temperature of the stack 100 is lowered through the evaporation. The evaporation of the coolant may be performed immediately after the coolant is injected into the evaporating/cooling unit 130 of the stack 100 in the injector 330, reflecting that the temperature of the stack 100 is high.

The vapor formed as the coolant, along with air, is evaporated in the evaporating/cooling unit 130 of the stack 100 may be introduced into the cathode 120 operating as air electrode of the stack 100. A passage (e.g., a pipe) 135 may be formed between the evaporating/cooling unit 130 and the cathode 120 of the stack 100 such that the air and the evaporated vapor may flow therebetween.

Additionally, the moisture introduced into the cathode 120 of the stack 100 may be used to supply moisture necessary for maintaining performance of an electrolyte membrane (not shown) between the cathode 120 and the anode 110 of the stack 100. In this way, the high-temperature/normal-pressure fuel cell according to the exemplary embodiment of the present invention connects the air supply unit 300 and the cooling/circulating system, thereby lowering the temperature of the stack 100 of the fuel cell while supplying the moisture necessary for the electrolyte membrane of the fuel cell through the air electrode.

In the exemplary embodiment of the present invention, moisture leftover after the moisture has been supplied from the cathode 120 to the electrolyte membrane may be returned to the radiator 430 to be cooled. The moisture then dissipates heat in the radiator 430 and becomes a liquid coolant again that is again reintroduced into the system. A fan 440 for blowing air into the radiator 430 may be installed adjacent to the radiator to further increase the heat dissipation efficiency of the radiator 430.

The coolant cooled by the radiator 430 of the fuel cell according to the exemplary embodiment of the present invention and reintroduced into the system may be stored in the coolant reservoir 410 again to be recirculated. Water formed after hydrogen and oxygen react with each other in the anode 110 of the stack 100 of the fuel cell may also be introduced into and stored in the coolant reservoir 410 so that a sufficient amount of water is always supplied to the system.

When a heat and mass balance is calculated on the exemplary fuel cell, the following result may be obtained.

After the fuel cell system to which the fuel cell cooling apparatus according to the exemplary embodiment of the present invention reaches a temperature of 90° C., a heat and mass balance calculation confirmed that the stack is sufficiently cooled by water through the evaporation and cooling of the water. The above calculation also confirmed that the humidity (e.g., relative humidity, and hereinafter a humidity refers to a relative humidity) of the air supplied to the cathode 120 of the stack 100 is as high as 47%.

This is a great improvement over the low-temperature/normal-pressure system that cannot be driven at a temperature of 90° C., and the high-temperature/high-pressure system that has a much lower relative humidity (i.e., about 30%).

It was also confirmed through results obtained by driving a fuel cell vehicle in which the fuel cell cooling apparatus according to the exemplary embodiment of the present invention has been implemented can sufficiently cool the stack 100 through evaporating and cooling the water via the means described above. Additionally, it was confirmed that the humidity of the air transferred to the air electrode of the stack 100 can be maintained at as high of value of 76% which is a significant increase over the conventional high temperature/high-pressure fuel cells.

However, the low-temperature/normal-pressure system could not be operated at a temperature of 77.5° C., and it was confirmed that the high-temperature/high-pressure fuel cell system could maintain a humidity of only about 30%.

Thus, after the heat and mass balance was performed, it was confirmed that the high-pressure/normal-pressure fuel cell system to which the fuel cell cooling apparatus according to the exemplary embodiment of the present invention was applied could be operated at a low temperature and a ambient pressure or in a load range greater than that of the high-temperature/high-pressure fuel cell system and

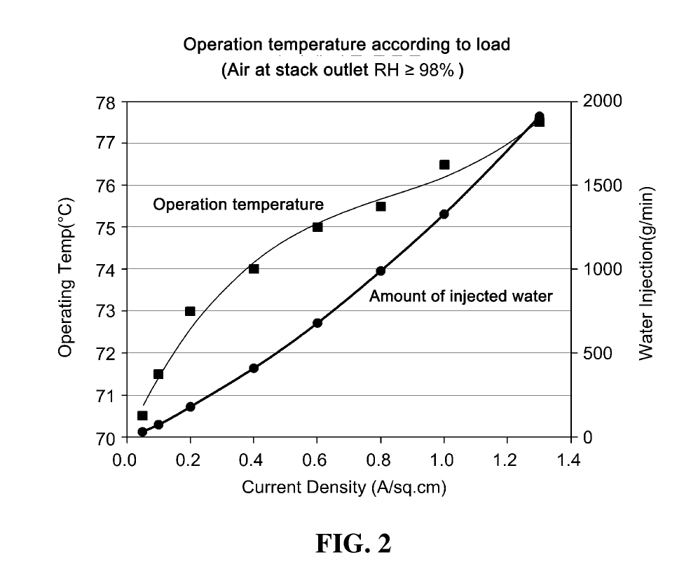

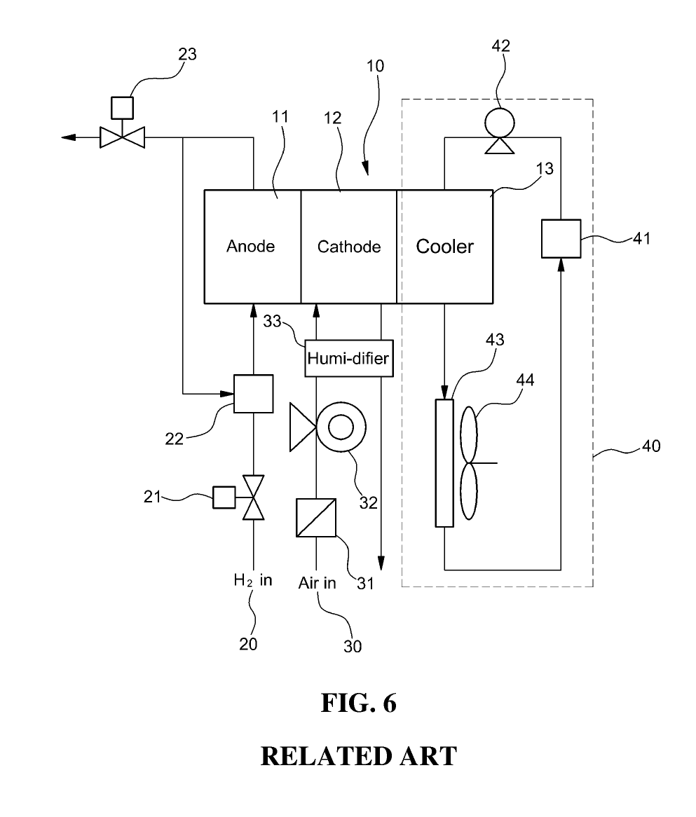

FIGS. 2 to 6 are graphs depicting schematically measured results in more detail. FIG. 2 is a graph depicting operation temperatures according to loads of a high-temperature/normal-pressure fuel cell system to which a fuel cell cooling apparatus according to an embodiment of the present invention is applied.

FIG. 2 illustrates that the amount of coolant supplied into the stack 200 is increased by increasing an operation temperature of the fuel cell based on load increments. Further, it was confirmed that an output current of the fuel cell system to which the fuel cell cooling apparatus according to the exemplary embodiment of the present invention continues to increase as an operation temperature of the fuel cell system increases. Thus, it was confirmed that the high-temperature/normal-pressure fuel cell system according to the exemplary embodiment of the present invention can reduction in efficiency of the fuel cell while still continuously supplying moisture to the stack 100.

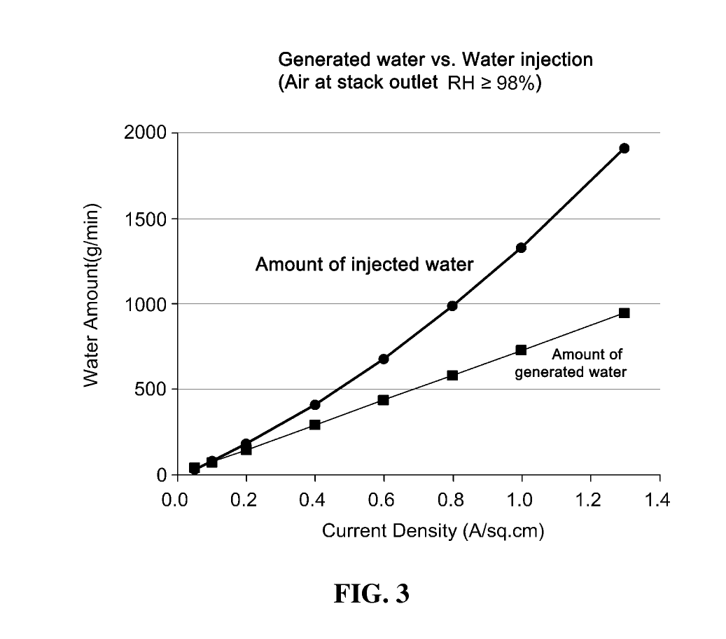

FIG. 3 is a graph depicting a relationship between an amount of coolant supplied to the high-temperature/normal-pressure fuel cell system to which the fuel cell cooling apparatus according to the exemplary embodiment of the present invention and an amount of coolant generated in a stack 100.

FIG. 3 illustrates that an amount of water generated by the fuel cell stack linearly increases according to current density when the water supply is increased to the stack in order to remove heat generated during an operation of the fuel cell.

FIG. 3 also illustrates through graphical depiction that a larger amount of water than the amount of the water generated through a reaction of hydrogen and oxygen should be supplied to the fuel cell system to cool the stack through the evaporation and cooling of the water.

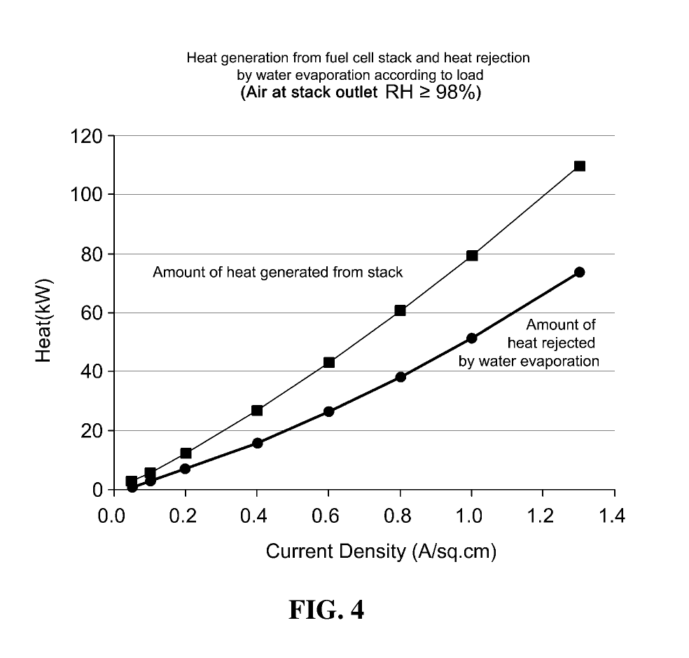

FIG. 4 is a graph depicting a relationship between an amount of heat within the stack 100 due to an increase in a load and a cooling rate corresponding thereto in the high-temperature/normal-pressure fuel cell system to which the fuel cell cooling apparatus according to the exemplary embodiment of the present invention is applied.

FIG. 4 illustrates that an amount of evaporated water increase as an amount of heat generated by the stack 100 increases in the high-temperature/ambient pressure fuel cell system to which the fuel cell cooling apparatus according to the exemplary embodiment of the present invention is applied. Thus, FIG. 4 provides evidence that the coolant injected into the evaporating/cooling unit 130 in the stack 100 efficiently removes heat generated in the stack 100.

FIG. 4 also shows that heat energy corresponding to about 70% of the heat generated by the stack 100 is removed while the coolant injected into the evaporating/cooling unit 130 is evaporated. The remaining amount of heat within the stack 100 is removed through evaporation of the water by the cathode 120 which operates as an air electrode that can be seen in FIG. 3.

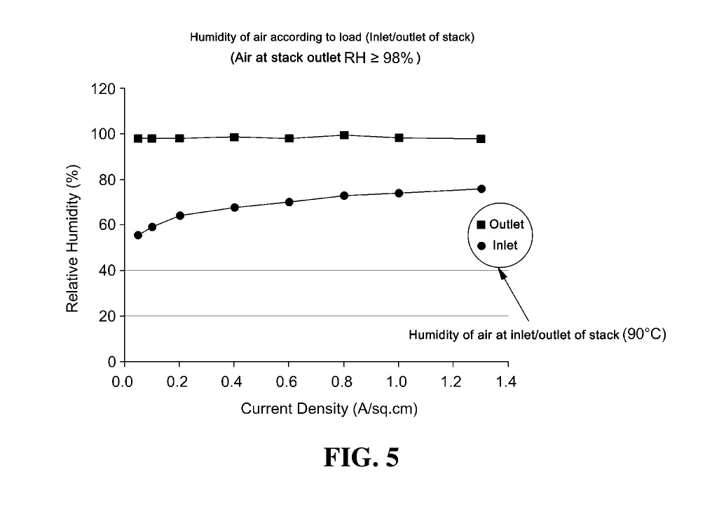

FIG. 5 is a graphical representation illustrating the amount of humidity at an inlet and an outlet of the stack 100 in the high-temperature/normal-pressure fuel cell system to which the fuel cell cooling apparatus according to the exemplary embodiment of the present invention is applied. The line obtained by connecting points the circular dots on the graph in FIG. 5 shows a graph of the humidity of air at an inlet of the stack 100, and the line obtained by connecting points square dots in FIG. 5 shows a graph of the humidity of air at an outlet of the stack 100. Further, a result obtained by operating a fuel cell at a temperature of about 90° C. is also shown in FIG. 5.

It was confirmed that a humidity of air at an inlet of the stack 100 is about 70% to 78% and a humidity of air at an outlet of the stack 100 is about 98% in the high-temperature/normal-pressure fuel cell system according to the exemplary embodiment of the present invention. Thus, this provides evidence that a sufficient amount of moisture can be provided an electrolyte in the fuel cell system to which the fuel cell cooling apparatus according to the exemplary embodiment of the present invention is applied. This also provides evidence that a reaction of hydrogen and oxygen can be normally carried out by maintaining an amount of moisture discharged from the stack 100 of the fuel cell at a high level.

Although the exemplary embodiments of the present invention have been described until now, it will be appreciated that those skilled in the art to which the present invention pertains can variously modify and change the present invention without departing from the spirit of the present invention claimed in the claims.

What is claimed is:

1. A fuel cell cooling apparatus comprising:
an evaporating/cooling unit installed in a stack of a fuel cell, and operably configured and disposed to lower a temperature of a stack;
an injector operably configured and disposed to inject a cooling material into the evaporating/cooling unit;
a pump operably configured and disposed to apply a pressure necessary to inject the cooling material; and
a passage connecting the evaporating/cooling unit to a cathode and disposed in the fuel cell cooling apparatus so that the cooling material evaporated in the evaporating/cooling unit passes through the passage and to the cathode.

2. The fuel cell cooling apparatus of claim 1, wherein the cathode supplies the cooling material injected through the passage and evaporated to an electrolyte membrane.

3. The fuel cell cooling apparatus of claim 2, further comprising:
a radiator that emits heat from the cooling material to the outside to liquefy the evaporated cooling material left after being supplied from the cathode to the electrolyte membrane;
a fan that introduces air to the radiator to increase a heat transfer efficiency of the radiator;
a water pump that supplies the cooling material to the injector; and
a reservoir that stores water generated due to a chemical reaction of hydrogen and oxygen in the stack of the fuel cell and water retrieved from the radiator.

4. The fuel cell cooling apparatus of any one of claims 1, wherein the cooling material is water.

5. A fuel cell cooling method comprising:
injecting, by an injector, a cooling material;
evaporating, by an evaporating/cooling unit, the cooling material in;
introducing the evaporated cooling material to a cathode of a fuel cell; and
supplying moisture to an electrolyte membrane of the cathode of the fuel cell by introducing the evaporated cooling material into the cathode of the fuel cell.

6. The fuel cell cooling apparatus of claim 5, further comprising: after supplying moisture to an electrolyte membrane of the cathode of the fuel cell through the evaporated cooling material introduced into the cathode of the fuel cell,
dissipating, by a radiator, heat from the evaporated cooling material to liquefy the cooling material; and
storing the liquefied cooling material in a reservoir.

7. The fuel cell cooling method of claim 5, wherein the cooling material is water.
